(19) United States
(12) Patent Application Publication
(10) Pub. No.: US 2009/0084036 A1
(43) Pub. Date: Apr. 2, 2009

(54) Method and device for achieving better heat transfer when using pulse heaters

(76) Inventor: Oliver Neumann, Offenbach (DE)

Correspondence Address: Nixon Peabody LLP, 200 Page Mill Road, Suite 200, Palo Alto, CA, 94306, US

(21) Appl. No.: 12/249,962

(22) Filed: Oct. 12, 2008

Related U.S. Application Data
(63) Continuation of application No. PCT/EP2007/052258, filed on Mar. 9, 2007.

(30) Foreign Application Priority Data
Apr. 11, 2006 (DE) 10 2006 017 355.4

(51) Int. Cl. C10J 3/02; F23J 15/08; C10J 3/10; C10J 3/20; B01J 19/24; B01J 7/00; B01J 8/18

(52) U.S. Cl. 48/197 R; 432/186; 432/15; 422/200

(57) ABSTRACT

The invention relates to heat exchanger tubes acting like resonant tubes of a Helmholtz resonator and used as swirl tubes. They are capable of drastically increasing heat transfer in the boundary layers determining the heat flow to be exchanged as a result of their geometrically deformed surfaces.

### CROSS REFERENCE TO RELATED APPLICATIONS

This application is a continuation of PCT/EP2007/052258 filed Mar. 9, 2007, which claims priority to DE 10 2006 017 355.4 filed Apr. 11, 2006, both of which are incorporated by reference.

### FIELD OF THE INVENTION

The invention relates to a pulse heater and corresponding methods improving heat transfer in gasification processes.

### BACKGROUND

The development of thermal gasification methods has produced essentially three different types of gasifier, namely entrained bed gasifiers, fixed bed gasifiers and fluidised bed gasifiers.

Primarily fixed bed gasifiers and fluidised bed gasifiers have been developed further for commercial gasification.

Of the many different technical approaches in the field of fixed bed gasification, the Carbo V method will be described by way of example here.

Relevant literature for fluidised bed gasification, which forms part of this application, is as follows: “High-Temperature Winkler Gasification of Municipal Solid Waste”; Wolfgang Adlhoch, Rheinbraun A G, Hisaaki Sumitomo Heavy Industries, Ltd., Joachim Wolff, Karsten Radtke (speaker), Krupp Uhde GmbH; Gasification Technology Conference; San Francisco, Calif., USA; Oct. 8-11, 2000; Conference Proceedings.

Relevant literature for circulating fluidised beds in a combined system, which forms part of this application, is as follows: “Dezentrale Strom—und Wärmeerzeugung auf Basis Biomasse-Vergasung”; R. Rauch, H. Hofbauer; Lecture, Uni Leipzig, 2004. “Zirkulierende Wirbelschicht, Vergasung mit Luft, Operation Experience with CfB—Technology for Waste Utilisation at a Cement Production Plant” R. Wirthwein, P. Scur, K.-F. Scharf —Rüddersdorfer Zement GmbH, H. Hirschfelder—Lurgi Energie und Entsorgungs GmbH; 7^{th} International Conference on Circulating Fluidized Bed Technologies; Niagara Falls, May 2002.

Relevant literature for combined fixed beds (rotating tube), which forms part of this application, is as follows: 30 MV Carbo V Biomass Gasifier for Municipal CHP; The CHP Project for the City of Aachen, Matthias Rudloff, Lecture, Paris, October 2005.

Relevant literature for combined systems for fixed bed gasification (slag tap gasifier), which forms part of this application, is as follows: Operation Results of the BGL Gasifier at Schwarze Pumpe, Dr. Hans-Joachim Sander SVZ; Dr. Georg Daradimos, Hansjobst Hirschfelder, Envirotherm; Gasification Technologies 2003; San Francisco, Calif.; Oct. 12-15, 2003; Conference Proceedings.

In the Carbo V method, gasification takes place in two stages. The biomass is first split into its volatile and solid constituents at 500° C. A tarry gas and additionally “wood charcoal” are produced. The gas is burnt at temperatures in excess of 1200° C., the tars breaking down to CO₂ and H₂. A product gas containing CO and H₂ is then produced with the hot flue gas and the wood charcoal.

As a result of the high technical complexity and the high costs due to the high pressure level (up to 40 bar), gasifiers of these types are completely unsuitable for the gasification of biomass (which occurs regionally and has a significant influence on the costs for logistics and processing).

Fluidised bed gasifiers can be divided into two methods differing from one another by the heating of the fluidised bed, namely circulating fluidised bed gasifiers and stationary fluidised bed gasifiers.

Relevant literature for desulphurisation in fluidised bed gasification, which forms part of this application, is as follows: Gasification of Lignite and Wood in the Lurgi Circulating Fluidized Bed Gasifier; Research Project 2656-3: Final Report, August 1988, P. Mehrling, H. Vierrath; LURGI GmbH; for Electric Power Research Institute, Palo Alto, Calif.: ZWS-Druckvergasung im Kombiblock, Final Report BMFT FB 03 E 6384-A; P. Mehrling, LURGI GmbH; Bewag.

An allothermal circulating fluidised bed gasification plant was put into operation in Güissing (Austria) at the beginning of 2002. The biomass is gasified in a fluidised bed with steam as an oxidising agent. In order to provide the heat for the gasification process, part of the wood charcoal produced in the fluidised bed is burnt in a second fluidised bed. The gasification under steam produces a product gas. The high initial costs for the plant technology and excessive process control costs have a disadvantageous effect.

One of the crucial problems with all of these approaches is the efficient use of the burners.

### SUMMARY OF THE INVENTION

The invention relates to a method and a device for improved heat transfer using pulse heaters. These pulse heaters can be used in gasifiers.

One possible field of application is the use of pulse heaters in the thermal gasification of biomass. No other known method is capable of producing a high-quality synthesis gas at unrivalled low cost, as a result of comparatively low investment costs, with CO₂ reduction, or of utilising it as energy and simultaneously processing it into a fuel, after appropriate cooling and purification.

In the possible field of application, the biomass is also gasified in a fluidised bed with steam as an oxidising and fluidising medium, although in this case it is a stationary fluidised bed with two specially developed pulse heaters allowing for the indirect introduction of heat into the fluidised bed situated in the reactor.

The advantage over fixed bed gasifiers and circulating fluidised beds is the absence of distinct temperature and reaction zones. The fluidised bed comprises an inert bed material. This thus ensures that the individual partial reactions take place simultaneously, as well as a uniform temperature (approximately 800° C.). The method is almost pressureless (up to a maximum of 0.5 bar) and can therefore be carried out in a problem-free manner from a technical point of view. It is characterised by high cost-effectiveness. The initial costs are lower than those of the aforesaid types of gasifier.

The starting point for further utilisation as a fuel is the medium-calorific gas from the bio-synthesis gas plant (on the basis of renewable raw materials), which, after removing dust and washing out condensable hydrocarbons (oil quenching), can be compressed to approximately 20 bar by means of a turbocompressor and refined by the following process steps:
gas purification and CO₂ removal by means of a rectisol plant
optimisation of the H₂ to CO ratio by means of the shift method
Fischer-Tropsch synthesis
discharge to a preferred hydrocracker/production diesel with a very high cetane number.

It can consequently be stated that the use of the subject matter according to the invention allows for a method in which 23 t high-quality fuel can be produced from 100 t biomass on the basis of the synthesis gas.

It will be clear that the claimed pulse heater is not limited to this use. A plurality of other applications are conceivable.

The method according to the invention and the corresponding devices are provided with integrated pilot burners allowing for optimum energetic utilisation of the main fuel (propane gas, natural gas or synthesis gas) or the simultaneous combustion of several types of gas in a specific manner with high efficiency. The heat preferably serves to produce reaction heat for steam conversion.

The method and the device are designed to achieve higher heat transfer. In the preferred embodiment, this is desired between the flue gases and the fluidised bed, wherein a simultaneous reduction in the number of resonant tubes of the pulse heaters should be ensured.

In this respect, swirl tubes are used for the heat exchanger tubes arranged downstream of the combustion chamber and acting like resonant tubes of a Helmholtz resonator. These are capable of drastically increasing heat transfer in the boundary layers determining the heat flow to be exchanged as a result of their geometrically deformed surfaces. The result is an additional improvement in heat transfer between the flue gas and the tube wall, resulting in the parallel use of both methods, i.e. pulsation and surface shape of the heat exchanger tubes, and an improvement and increase in heat transfer during part-load operation of the pulse heaters. This increase in the load performance leads to an improvement in and simplification of management. The increase in heat transfer moreover allows for a reduction in the number of pulse tubes while maintaining their serviceability. Reducing the corresponding number increases the lane width between the tubes, this additionally increasing heat transfer on the part of the fluidised bed.

As a result of this optimisation of material transport within the fluidised bed, heat transfer, as well as mass exchange and the reaction speed of the reactions during the gasification process are increased significantly.

### DESCRIPTION OF THE FIGURES

The figures serve to describe the invention and for a clearer understanding of the following detailed description of the preferred embodiment.

FIG. 1 shows a pulse tube in which the pulse shock results in a swirl;

FIG. 2 shows a pulse heater with pilot burners, and

FIG. 3 shows the arrangement of three pulse heaters in a gasification reactor.

### DETAILED DESCRIPTION

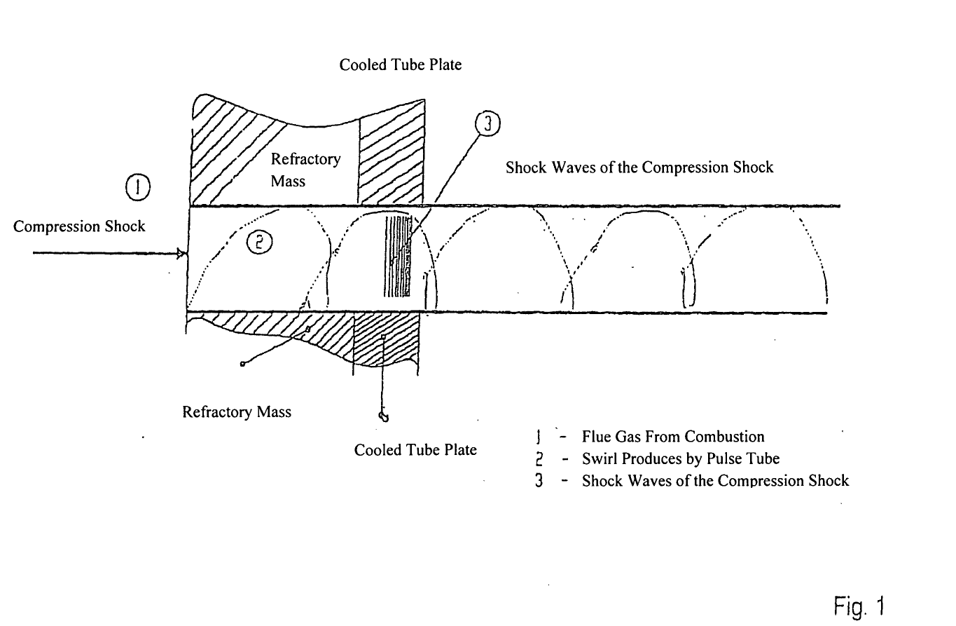

FIG. 1 shows a pulse tube 2 comprising embossing, so that the compression shock 1 produced by combustion results in a swirl. The shock waves of the compression shock 3 move spirally through the pulse tube. This is generally achieved in that embossed areas or bulges are formed within the pulse tube on the inside thereof, these converting the compression shock into a rotational movement. The pulse tube, which absorbs the compression shock 1, is initially surrounded by a refractory mass and is held by a cooled tube plate. As a result of the great heat of the compression shock, appropriate fixing is required and cooling is essential so that there is no damage to the burner.

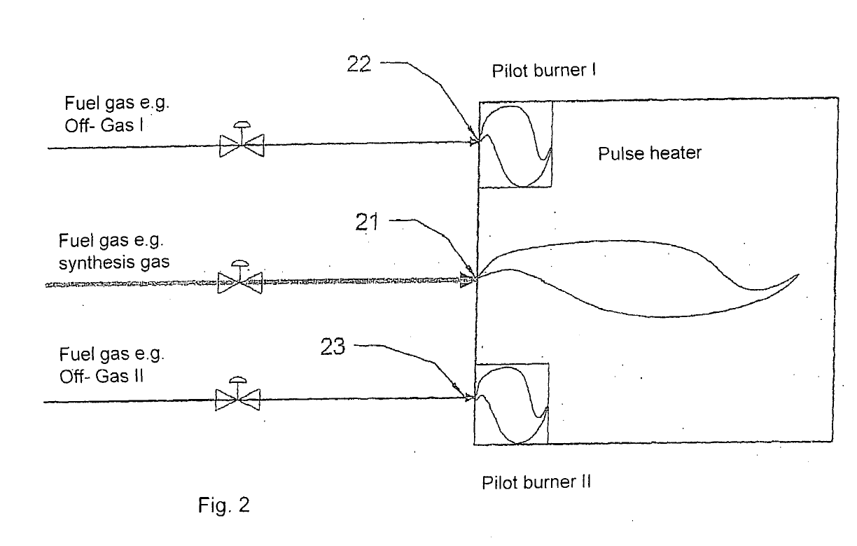

FIG. 2 shows a pulse heater 21 preferably used in a gasification reactor. The latter is additionally provided with a main burner operated with fuel gas, e.g. the synthesis gas produced by the gasification reactor. Two pilot burners 22 and 23 are furthermore provided, operated with fuel gas, e.g. off-gas I and II. These gases are, e.g. recycle purge gas from the downstream synthesis processes for the production of fuel (petrol or diesel).

The pilot burners are also subjected within the context of control logic to the pulsating deviations of the pulse tubes and primarily fulfil the purpose of heating the combustion chamber to approximately 1000° in order to provide optimum conditions for the synthesis gas. Alternatively, the gas is ignited (as it enters the combustion chamber) by using a high-energy ignition rod. The energy required for ignition is produced by a separate ignition device. The ignition tip is made from high temperature resistant or ceramic materials and is designed for continuous exposure to temperatures of preferably more than 1200°.

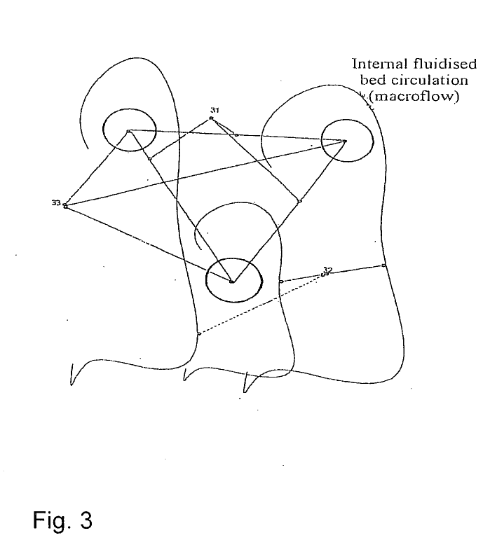

FIG. 3 once again shows the arrangement of the pulse tubes in the reactor. Three pulse tubes are arranged if possible in a triangle so that they produce a macroflow which produces a static fluidised bed. The reference numeral 31 designates the lane spacing between the pulse tubes. The reference numeral 32 determines the stream filaments of the macroflow of the fluidised bed material. As a result of the sectional view, the reference numeral 33 represents the cross section of the pulse tubes.

The preferred embodiments do not serve to limit the subject matter. They serve only for understanding. The scope of protection of the invention is determined by the claims.

1. Pulse heater with a resonant tube, wherein the surface in the interior or exterior of the resonant tube improving heat transfer from the interior of the resonant tube towards the exterior.

2. The pulse heater according to the preceding claim 1, in which the surface in the interior is deformed in such a manner that the pulsation and the surface shape of the resonant tube are combined without restricting the pulsation operation.

3. The pulse heater according to claim 1, in which the surface shape is designed in such a manner that a compression shock results in a swirl.

4. The pulse heater according to claim 1, in which at least one bulge is arranged spirally within the resonant tube.

5. The pulse heater according to claim 1, in which the resonant tube is surrounded at least partially by a cooled tube plate.

6. The pulse heater according to claim 1, in which the resonant tube is surrounded at least partially by a refractory mass.

7. The pulse heater according to claim 1, in which it is arranged in a gasification reactor.

8. The pulse heater according to claim 7, in which the gasification reactor is operated with biomass.

9. The pulse heater according to claim 1, located in a gasification reactor, including a main burner and a preheater.

10. The pulse heater according to claim 9, including one or more pilot burners designed as preheaters.

11. The pulse heater according to claim 10, wherein the pilot burners are multi-fuel burners which can be operated with different gases.

12. The pulse heater according to claim 9, in which the preheater is an electric heater.

13. Gasification reactor for the gasification of solids, including at least three pulse heaters extending in the reactor and arranged in a triangle.

14. The gasification reactor according to claim 13, in which one pulse heater is arranged centrally below the other pulse heaters and two further pulse heaters are arranged in an offset manner above the first pulse heater, thereby forming a triangle as viewed in the longitudinal direction.

15. The gasification reactor according to claim 13, wherein the surface in the interior or exterior of a resonant tube of the pulse heaters is build to improve heat transfer from the interior of the resonant tube towards the exterior.

16. Method for the production of a synthesis gas with a pulse heater comprising a resonant tube, including the steps:
introducing a fuel gas into the pulse heater;
improving heat transfer from the interior of the resonant tube towards the exterior by a surface in the interior or exterior of the resonant tube.

17. The method according to claim 16, in which the surface in the interior is deformed in such a manner that the pulsation and the surface shape of the resonant tube are combined without restricting the pulsation operation.

18. The method according to claim 16, in which the surface shape is designed in such a manner that a compression shock results in a swirl.

19. The method according to the preceding claim 18, in which at least one bulge is arranged spirally within the resonant tube.

20. The method according to claim 16, in which the resonant tube is surrounded at least partially by a cooled tube plate.

21. The method according to claim 16, in which the resonant tube is surrounded at least partially by a refractory mass.

22. The method according to claim 16, in which it is arranged in a gasification reactor.

23. The method according to claim 22, in which the gasification reactor is operated with biomass.

24. A pulse heater for a gasification reactor, including a main burner and a preheater.

25. The pulse heater according to claim 24, including one or more pilot burners designed as preheaters.

26. The pulse heater according to claim 24, in which the pilot burners are multi-fuel burners which can be operated with different gases.

27. The pulse heater according to claim 24, in which the preheater is an electric heater.

28. Method for the gasification of feed in a reactor by the use of pulse heaters, wherein the compression shock is being controlled in such a manner that the compression shock results in a swirl in the resonant tube.

29. The Method for the gasification according to claim 28, wherein the pulse heater in the region of a main burner is preheated.

30. The method according to claim 28, in which the main burner is preheated by a pilot burner, by gas combustion or by an electric burner.
